(19) United States
(12) Patent Application Publication
(10) Pub. No.: US 2007/0136580 A1
(43) Pub. Date: Jun. 14, 2007

(54) Method and system for tracking a data processing system within a communications network

(76) Inventors: Vaijayanthimala K. Anand, Austin, TX (US); Janice M. Girouard, Austin, TX (US); Emily J. Ratliff, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/301,108

(22) Filed: Dec. 12, 2005

(51) Int. Cl. H04L 9/00

(52) U.S. Cl. 713/168

(57) ABSTRACT

A method and system for tracking a data processing system within a communications network are provided. According to one embodiment, a method is provided comprising receiving identity data from a data processing system via a communications network, where the data processing system comprises a security processing element associated with a secure storage element and the identity data specifies a portion of a security processing element endorsement key stored within the secure storage element. The described method embodiment further comprises identifying the data processing system utilizing the identity data and causing corresponding recovery data to be stored in response to an identification of the data processing system, where the recovery data comprises an associated network connection address.

### BACKGROUND

1. Technical Field

Embodiments of the present invention relate generally to data processing system and communications network security and more particularly to a method and system for tracking a data processing system within a communications network.

2. Description of the Related Art

With the proliferation of communications networks and associated data processing systems, system security including physical security has become increasingly more important. Maintaining physical security of a data processing system may include being able to determine the physical location of the system for an associated user (e.g., to recover a system following a loss) and/or a service or data provider (e.g., to utilize physical location to verify or authenticate a user, to determine service rates or charges, or the like).

In conventional systems and networks the location of a data processing system is determined or “tracked” using one of a number of techniques. According to one technique, a system's specific physical location is determined by identifying the data processing system to be tracked and then determining the system's physical location. For example, a system may be identified using a media access control (MAC) address integral with a network interface (e.g., an Ethernet card) associated with the system and the location of the system may then be determined using an Internet Protocol (IP) address associated with that MAC address. Since the identification of a data processing system according to the described technique typically relies on elements (e.g., a network interface card) which may be easily changed (e.g., by using a substitute network interface card), systems and networks implementing such a technique may be easily thwarted.

According to another conventional technique, a determination is made, not of a data processing system's specific location, but rather whether or not a system is physically present within a defined area (e.g., a local area network, enterprise, data center, or the like) or associated with a class or group of elements which is in turn associated with such a defined area. For example, each data processing system of a data center, sub-network or local area network (LAN) may be provided with a private key of a public key infrastructure key pair with a corresponding public key being associated with, and made publicly available from, the described data center or network. Membership of a system within the data center or network may then be validated by requesting and receiving data encrypted using the described private key and attempting to decrypt such data using the corresponding public key. If valid data is obtained following the attempted decryption operation, a determination may be made that the system and data center or network are associated with one another.

Using the described technique, actual tracking of a system is performed manually by a data center or network entity (e.g., a network administrator) or using other known means. Following a determination that a system is no longer associated with or present within a data center or network, or that a data center or network-associated private key has been compromised, such an entity is responsible for revoking each private key. Moreover, since there is an essentially one to one correspondence between the public and private keys of a public key infrastructure key pair, networks or systems implementing such a technique must rely on associated data processing systems to not continue to use a data center or network's associated private key improperly (e.g., fraudulently) or alternatively to create a new key pair, re-validate each system's association with the data center or network, and distribute private keys each time any system is separated or a private key becomes compromised.

According to yet another conventional technique, additional hardware may be utilized to make a determination of a data processing system's relative position (e.g., that a system is within a defined proximity to a user) rather than of the data processing system's specific and absolute location. For example, a radio frequency identification (RFID) sensor may be incorporated within a data processing system and used to control operation of the system based upon a determination that the sensor is within a defined proximity to a user's RFID tag or other token or identifier. While potentially increasing the physical security of a data processing system, use of such a technique suffers from a number of shortcomings. More specifically, the use of such additional hardware solely for physical security may not be cost-effective for a given data processing system and in some instances (e.g., where a user's RFID tag and portable data processing system are stolen or otherwise lost together) may not provide any enhancement to a system's physical security.

### SUMMARY

A method and system for tracking a data processing system within a communications network are disclosed. According to one embodiment, a method is provided comprising receiving identity data from a data processing system. In the described embodiment, the data processing system comprises a security processing element and the identity data comprises data which specifies a portion of a security processing element endorsement key stored within secure storage associated with the security processing element. The described method embodiment further comprises identifying the data processing system utilizing the data which specifies the portion of the security processing element endorsement key and causing recovery data (e.g., a network connection address associated with the data processing system) corresponding to the data processing system to be stored in response to an identification of the data processing system.

The foregoing is a summary and thus contains, by necessity, simplifications, generalizations and omissions of detail; consequently, those skilled in the art will appreciate that the summary is illustrative only and is not intended to be in any way limiting. As will also be apparent from the accompanying description, the operations disclosed herein may be implemented in a number of ways including implementation in hardware, software, firmware, or a combination thereof, and such changes and modifications may be made without departing from the present invention and its broader scope. Other aspects, inventive features, and advantages of the present invention, as defined by the claims, will become apparent in the non-limiting detailed description set forth below.

### BRIEF DESCRIPTION OF THE DRAWINGS

The present invention may be better understood, and its numerous features and advantages made apparent to those skilled in the art by referencing the accompanying drawings in which:

FIG. 1 illustrates a communications network including a system recovery communications network element and a data processing system according to one or more embodiments of the present invention;

FIG. 2 illustrates a high-level internal block diagram of a data processing system according to an embodiment of the present invention;

FIG. 3 illustrates a security processing element according to an embodiment of the present invention;

FIG. 4 illustrates a high-level flow diagram of a data processing system operational process according to a first embodiment of the present invention;

FIG. 5 illustrates a high-level flow diagram of a data processing system operational process according to a second embodiment of the present invention; and

FIG. 6 illustrates a high-level flow diagram of a system recovery communications network element operational process according to an embodiment of the present invention.

The use of similar reference symbols in different drawings is intended to indicate similar or identical items.

### DETAILED DESCRIPTION OF AN ILLUSTRATIVE EMBODIMENT

The following sets forth a detailed description of at least the best-contemplated mode for carrying out the one or more methods and systems described herein. The description is intended to be illustrative and should not be taken to be limiting. In the following detailed description, numerous specific details such as specific method orders, structures, elements, and connections have been set forth. It is to be understood however that these and other specific details need not be utilized to practice embodiments of the present invention. In other circumstances, well-known structures, elements, or connections have been omitted, or have not been described in particular detail in order to avoid unnecessarily obscuring this description.

References within the present description to “one embodiment,” “an embodiment,” or “embodiments” are intended to indicate that a particular feature, structure, or characteristic described in connection with the embodiment is included in at least one embodiment of the present invention. The appearance of such phrases in various places within the present description are not necessarily all referring to the same embodiment, nor are separate or alternative embodiments mutually exclusive of other embodiments. Moreover, various features are described which may be exhibited by some embodiments and not by others. Similarly, various requirements may be described which are applicable to some embodiments but not other embodiments.

Embodiments of the present invention provide a method and system for tracking a data processing system within a communications network. According to one embodiment, a method is provided which comprises receiving identity data from a data processing system, wherein the data processing system comprises a security processing element such as a trusted platform module (TPM) as described in one or more of the TPM Specifications provided by the Trusted Computing Group (TCG) or its predecessor, the Trusted Computing Platform Alliance (TCPA). Such a data processing system may comprise any device or element capable of storing, transferring, replicating, analyzing, generating, communicating, assembling, composing, computing, resolving, or otherwise processing data. For example, a data processing system may comprise a desktop, laptop, notebook, or sub-notebook computer or other portable computing (e.g., a personal digital assistant) or communication (e.g., a “smart” or enhanced mobile telephone) device capable of being associated with a security processing element.

In the described embodiment, identity data comprises data which specifies a portion of a security processing element (e.g., TPM) endorsement key stored within secure storage associated with the security processing element. According to one embodiment, the described portion of the endorsement key (EK) comprises a public key of a public key infrastructure key pair (e.g., a TPM EK pair). The described method embodiment further comprises identifying the data processing system utilizing the data which specifies the portion of the security processing element endorsement key and causing recovery data corresponding to the data processing system to be stored in response to an identification of the data processing system where the recovery data comprises a network connection address (e.g., an IP address) associated with the data processing system.

According to another embodiment, a method as previously described is performed utilizing a system recovery communications network element. A network element may comprise any device (e.g., a data processing system) capable of being communicatively coupled to a communications network. Such a system recovery communications network element may therefore comprise any network element configured to be used to recover, track, and/or locate a lost (e.g., misplaced and/or stolen) data processing system. According to one embodiment, a system recovery communications network element comprises a communications network interconnect element (e.g., a router, hub, bridge, gateway, switch, or the like).

In one embodiment of the present invention a data processing system to be tracked and system recovery communications network element are each provided within a communications network. A security processing element (e.g., a TPM) within the data processing system is initially enabled (e.g., at boot or initial program load) and utilized to generate a local recovery key (e.g., a random asymmetric or symmetric encryption key) which is encrypted using a public global recovery key associated with the system recovery communications network element and which is used to encrypt a public trusted platform module endorsement key associated with the data processing system's security processing element. Identity data including both the encrypted local recovery key and encrypted public trusted platform module endorsement key are then provided to the system recovery communications network element.

In one embodiment, such identity data as previously-described is transmitted once per boot or IPL operation utilizing low (e.g., BIOS)-level program code within the data processing system. In another embodiment, a higher (e.g., application) level recovery program is provided and utilized to transmit identity data to the system recovery communications network element on a regular or periodic basis (e.g., as a heartbeat signal) such that movement of the data processing system may be ascertained and tracked and a warning message may be generated and/or transmitted to an associated user if a cessation of the identity data signal is detected. In the present description, the term “user” is not intended to be limited to an actual human user but rather to encompass a user identity or profile which may or may not be associated therewith, program code operating at an application or other level to provide user or “client” type functionality, and/or an “owner” or other entity which is associated with a data processing system independent of actual use.

Once received by the system recovery communications network element, the described identity data may be utilized (e.g., following the receipt of an additional “loss notification” signal) to identify the data processing system for recovery purposes. More specifically, a private global recovery key corresponding to the public global recovery key and associated with the system recovery communications network element may be used to decrypt the local recovery key which may in turn be used to decrypt the public trusted platform module endorsement key, thus identifying the data processing system.

According to one embodiment, identity data as described may be transmitted to a number of hierarchically-arranged communications network interconnect elements (e.g., routers, hubs, bridges, gateways, switches, or the like) within a communications network and processed by one or more selected elements having system recovery functionality. In one embodiment, the highest hierarchical level of system recovery-enabled communications network interconnect elements within a communications network is initially activated to track a lost (e.g., stolen or misplaced) data processing system utilizing a loss notification (e.g., a message, instruction, signal, or the like) indicating the identity of the data processing system and that the identified data processing system has been separated from an associated user.

Following activation, network traffic is processed (e.g., monitored) by the activated communications network interconnect element(s) to detect the receipt of identity data identifying the/a data processing system to be tracked. A sub-network of the communications network including the data processing system to be tracked is then identified (e.g., using an associated network connection address as further described herein) by at least one of the highest hierarchical level system recovery communications network elements. The loss notification is then forwarded (or a new loss notification is generated and transmitted) from the identifying high-hierarchical-level system recovery communications network element to one or more system recovery communications network elements at one or more hierarchical levels within the identified sub-network.

By selectively activating system recovery communications networks elements when a data processing system to be tracked is within an associated sub-network as described, the location of a data processing system may be determined quickly without requiring network traffic to be processed by other communications network elements unnecessarily. Moreover, any movement of a data processing system from one sub-network to another may be detected at hierarchically higher-level system recovery-enabled communications network interconnect elements which retain previously-transmitted loss notification(s).

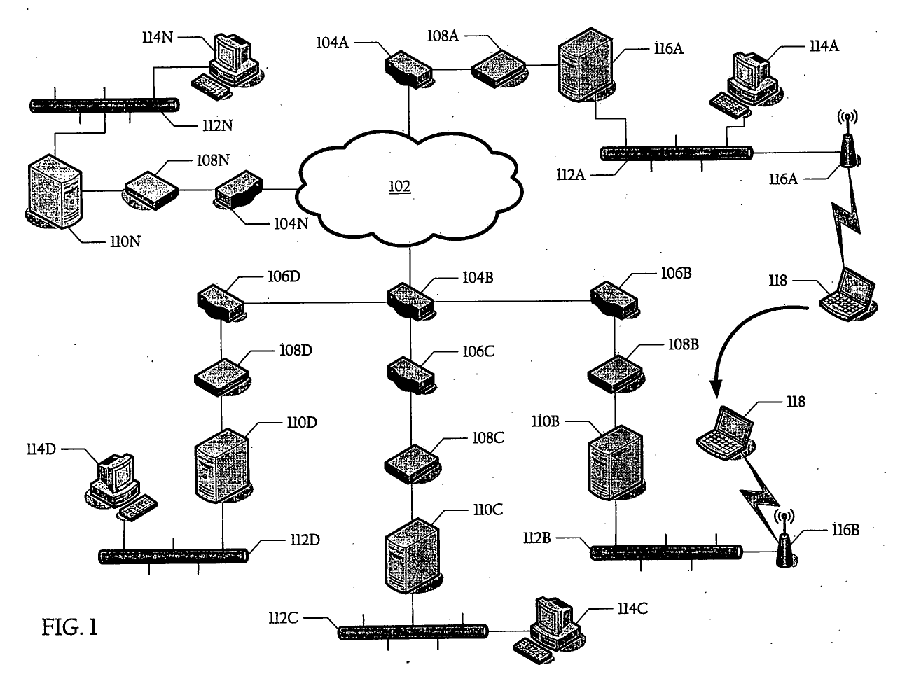

FIG. 1 illustrates a communications network including a system recovery communications network element and a data processing system according to one or more embodiments of the present invention. More specifically, FIG. 1 depicts a communications network 100 including a number of sub-networks communicatively coupled to one another via a core network 102 and network interconnect elements (e.g., gateways 104A, 104B . . . 104N). According to one embodiment, communications network 100 comprises the Internet or another wide-area or metropolitan area TCP/IP-based network.

In the illustrated embodiment of FIG. 1, a mobile data processing system 118 to be tracked is initially communicatively coupled to or otherwise associated with a first sub-network coupled to core network 102 via a first gateway 104A. In the illustrated embodiment, the described first sub-network includes a network segment comprising a server 110A coupled to core network 102 via gateway 104A and a communications adapter 108A (e.g., a digital subscriber line or cable modem, a digital service unit, or the like). Server 110A is in turn coupled to one or more other communications network elements or nodes (e.g., desktop data processing system 114A and mobile data processing system 118) via a network communication medium 112A or link and wireless access point 116A as shown.

Communications network 110 of the illustrated embodiment of FIG. 1 similarly includes other sub-networks including similar network elements as shown. It should be appreciated however that the number of sub-networks and the component elements thereof illustrated in FIG. 1 are shown merely for purposes of illustration and that embodiments of the present invention may be implemented in communications networks having any number of sub-networks, each including any number of network elements. More specifically, second, third, and fourth sub-networks have been depicted coupled to core network 102 via a second gateway 104B and corresponding hierarchically lower-level communications network interconnect element (e.g., routers 106B, 106C, and106D, respectively) and an “Nth” sub-network is also shown, coupled to core network 102 via an “Nth” gateway 104N, where “N” is intended to indicate some positive integer number. Use of the descriptor “N” or “n” with regard to multiple sets of elements within the present description is not intended to indicate necessarily the same number of elements in each case. While gateways 104 have been depicted herein, in alternative embodiments any communications network interconnect element(s), at least one of which includes system recovery functionality may be utilized.

By way of example, a process by which mobile data processing system 118 may be tracked within communications network 100 will now be briefly described. As previously described, mobile data processing system 118 is initially communicatively coupled to or otherwise associated with a first sub-network (e.g., a wireless hotspot at an airport, a wireless LAN at an enterprise or business, or the like) including wireless access point (WAP) 116A. Thereafter, mobile data processing system 118 is “lost” (e.g., stolen or misplaced) and consequently disassociated from the described first sub-network and communicatively coupled to or otherwise associated with a second sub-network including wireless access point 116B.

While a particular loss scenario has been depicted in FIG. 1, a number of variations are contemplated in alternative embodiments of the present invention. For example, while a mobile data processing system has been shown, system recovery or “tracking” operations according to embodiments of the present invention may be performed on any of a number of data processing systems (e.g., desktop data processing systems, enhanced or “smart” mobile telephones, personal digital assistants, or the like). Similarly, while tracking or system recovery has been illustrated in conjunction with the movement of a data processing system in FIG. 1, a stationary data processing system may also be “tracked” or located. For example, embodiments of the present invention may be utilized to locate a particular data processing system in a large information technology (IT) infrastructure or enterprise (e.g., a server farm, data center, network, or the like) or to locate a mobile data processing system which has been unintentionally left behind at one of a number of locations visited by a user.

Following the disassociation of mobile data processing system 118 from the described first sub-network, a loss notification is generated to indicate that the data processing system and an associated user have become separated. In various embodiments, a loss notification may be generated using any of a number of techniques The loss notification may be received by a particular system recovery-enabled communications network element and retransmitted to one or more hierarchically high-level system recovery communications network elements within communications network 100 or may be immediately transmitted (e.g., via broadcast or multicast) to such elements. More specifically in the embodiment of FIG. 1, a loss notification is transmitted, at least initially, to each of gateways 104A, 104B . . . 104N at a hierarchically highest level of communications network 100.

Receipt of a loss notification activates each of the receiving system recovery communication networks elements including gateway 104B to perform one or more processes of the present invention, thereby processing (e.g., monitoring) received communications network traffic to detect the receipt of identity data corresponding to mobile data processing system 118. Once such identity data is received, an associated network connection address (e.g., an IP address associated with a datagram or packet including the received identity data) may be stored locally and/or utilized to determine the position (e.g., a network connection point, node, or port) of mobile data processing system 118.

In the illustrated embodiment, a network connection address associated with mobile data processing system 118 and identity data transmitted to gateway 104B therefrom is utilized to identify the described second sub-network at gateway 104B. Once the second sub-network has been identified, a loss notification including data which identifies mobile data processing system 118 and its loss is transmitted to one or more hierarchically lower-level system recovery communications network elements within the identified sub-network (e.g., router 106B). In the described manner, a loss notification (and concomitant activation of system recovery communications network elements) may be propagated throughout communications network 100, thus verifying the precise location of the data processing system to be tracked while conserving network resources and enabling continued tracking should additional movement occur.

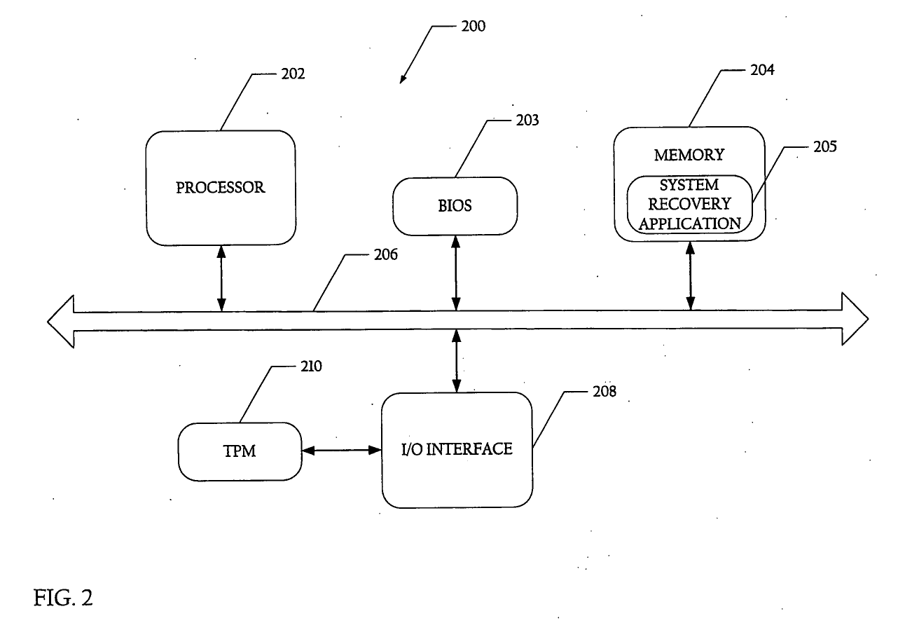

FIG. 2 illustrates a high-level internal block diagram of a data processing system (e.g., mobile data processing system 118 depicted in FIG. 1) according to an embodiment of the present invention. While a particular number and arrangement of elements have been illustrated with respect to data processing system 200 of FIG. 2, it should be appreciated that embodiments of the present invention are not limited to data processing systems having any particular number, type, or arrangement of components and so many encompass a wide variety of data processing system types, architectures, and form factors (e.g., network elements or nodes, personal computers, workstations, servers, or the like). Data processing system 200 of the illustrated embodiment includes a processor 202 coupled to a BIOS 203 and a memory 204 utilizing a communication medium (e.g., bus 206). Memory 204 may comprise any of a number of system memory-type storage elements such as random access memory (RAM), read-only memory (ROM), flash memory, and cache.

Data processing system 200 of the illustrated embodiment further comprises an input/output (I/O) interface 208 coupled to bus 206 to communicatively couple one or more I/O devices including a security processing element (e.g., TPM 210) to data processing system 200. Additional exemplary I/O devices may include traditional I/O devices such as keyboards, displays, printers, cursor control devices (e.g., trackballs, mice, tablets, etc.), speakers, and microphones; storage devices such as fixed or “hard” magnetic media storage devices, optical storage devices (e.g., CD or DVD ROMs), solid state storage devices (e.g., USB, Secure Digital SD™, CompactFlash™, MMC, or the like), removable magnetic medium storage devices such as floppy disks and tape, or other storage devices or mediums; and wired or wireless communication devices or media (e.g., communication networks accessed via modem or direct network interface).

Embodiments of the present invention may include software, information processing hardware, and various processing operations further described herein. The features and process operations of the present invention may be embodied in executable instructions and/or program code embodied within a machine-readable medium such as memory 204, a storage device, a communication device or medium, or the like. More specifically in the embodiment of FIG. 2, system recovery functionality is embodied within program code of BIOS 203 and/or a data processing system recovery application 205 within memory 204.

A machine-readable medium may include any mechanism that provides (i.e., stores and/or transmits) data in a form readable by a machine (e.g., data processing system 200). For example, a machine-readable medium includes but is not limited to: random access memory (RAM); read only memory (ROM); magnetic storage media; optical storage media; flash memory devices; electrical, optical, and/or acoustical propagated signals (e.g., carrier waves, infrared signals, digital signals, etc.); or the like.

The described executable instructions can be used to cause a general or special purpose processor such as processor 202, programmed with the instructions, to perform operations, methods or processes of the present invention. Alternatively, the features or operations of the present invention may be performed by specific hardware components that contain hard-wired logic for performing the operations, or by any combination of programmed data processing components and custom hardware components.

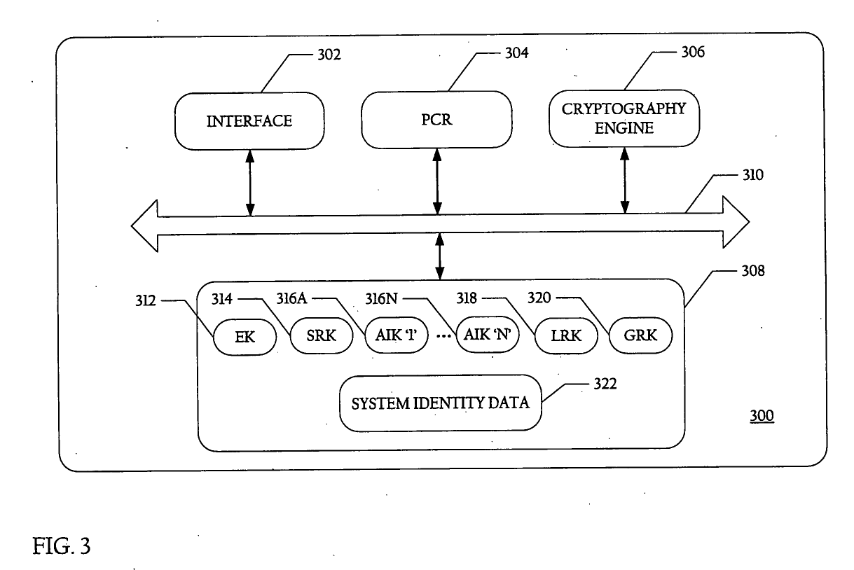

FIG. 3 illustrates a security processing element according to an embodiment of the present invention. In one embodiment, a security processing element 300 of FIG. 3 comprises a trusted platform module (TPM) as described in one or more of the TPM Specifications provided by the Trusted Computing Group (TCG) or its predecessor, the Trusted Computing Platform Alliance (TCPA). Similar in structure to data processing system 200 of FIG. 2, security processing module 300 in the illustrated embodiment includes a host data processing system interface 302 (e.g., a low pin count interface), one or more platform configuration registers 304, a cryptographic engine 306, and secure storage 308 coupled together via a communication medium 310. Platform configuration registers 304 are utilized to store integrity metric data for a host data processing system associated with security processing element 300. Cryptography engine 306 may comprise any general or special-purpose processing element capable of implementing one or more symmetric or asymmetric cryptographic algorithms.

Secure storage 308 of the illustrated embodiment of FIG. 3 includes a number cryptographic keys 312-320 as well data processing system identity data 322 utilized in conjunction with one or more embodiments of the present invention. Each of cryptographic keys 312-320 may comprise a single symmetric key or one or more keys of an asymmetric or “public” key infrastructure key pair. Exemplary cryptographic keys in the embodiment of FIG. 3 include a TPM endorsement key 312, a storage root key 314, a number of attestation identity keys 316A . . . 316N, a local recovery key 318, and a global recovery key 320 as shown. In one embodiment of the present invention, endorsement key 312 comprises a public key infrastructure key pair including a public trusted platform module endorsement key and a private trusted platform module endorsement key. Endorsement key 312 may be utilized in one or more embodiments to identify an associated host data processing system as validly or authentically including security processing element (e.g., TPM) 300 as well as to decrypt information and during the installation of a security processing element owner. Storage root key 314 is utilized to securely store other, hierarchically lower-order keys and other data within secure storage 308. Attestation identity keys (AIKs) 316A . . . 316N are utilized for data processing system authentication, attestation and certification of keys.

In the embodiment of FIG. 3, local recovery key 318 and a global recovery key 320 within secure storage 308 may be utilized in conjunction with one or more embodiments of the present invention. More specifically, local recovery key 318 is a random key generated locally (e.g., using cryptography engine 306) to security processing element 300. According to one embodiment, local recovery key 318 is utilized to encrypt or sign at least a (e.g., public) portion of TPM endorsement key 312. In the described embodiment, local recovery key 318 is in turn encrypted or signed utilizing at least a (e.g., public) portion of global recovery key 320 which is associated with one or more system recovery communications network elements. The encrypted keys may then be utilized to track an associated data processing system as described more fully herein.

In one embodiment, identity data including encrypted versions of both local recovery key 318 and TPM endorsement key 312 is received at a system recovery communications network element from a data processing system associated with security processing element 300. Upon receipt, local recovery key 318 is decrypted utilizing at least a (e.g., corresponding private) portion of global recovery key 320. The decrypted local recovery key may then be used to decrypt the received portion of TPM endorsement key 312 previously described. Using the decrypted endorsement key data a specific data processing system may be identified and using a network connection (e.g., IP) address associated with the identity data's transmission a specific location or network connection can be determined.

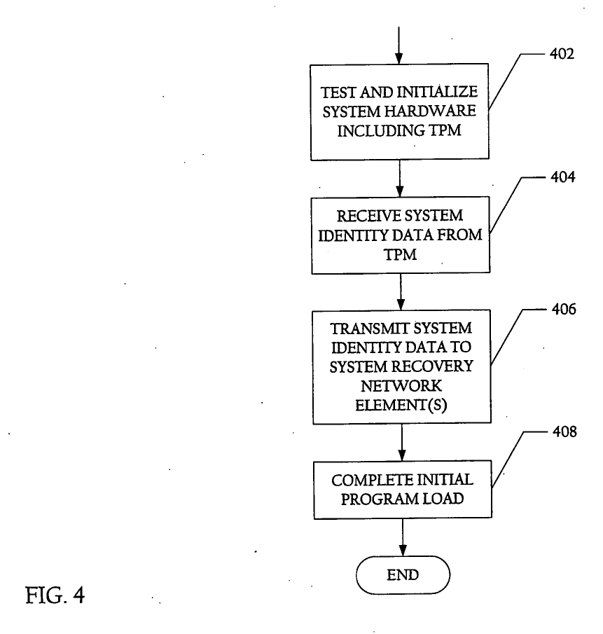

FIG. 4 illustrates a high-level flow diagram of a data processing system (e.g., BIOS) operational process according to a first embodiment of the present invention. In the illustrated processing embodiment, data processing system hardware including a TPM or other security processing element is tested and initialized (process block 402). Thereafter, data processing system identity data as described herein is received from the TPM (process block 404). Such identity data may include any data generated by or associated with a security processing element such as a TPM which may be used to definitively identity an associated data processing system. In one embodiment, identity data includes an encrypted version of a public trusted platform module endorsement key. Once received, the described identity data is transmitted to one or more data processing system recovery network elements (process block 406) to be utilized to track (e.g., determine the location of) an associated data processing system. Thereafter in the illustrated embodiment of FIG. 4 initial program load (e.g., boot) operations are completed (process block 408).

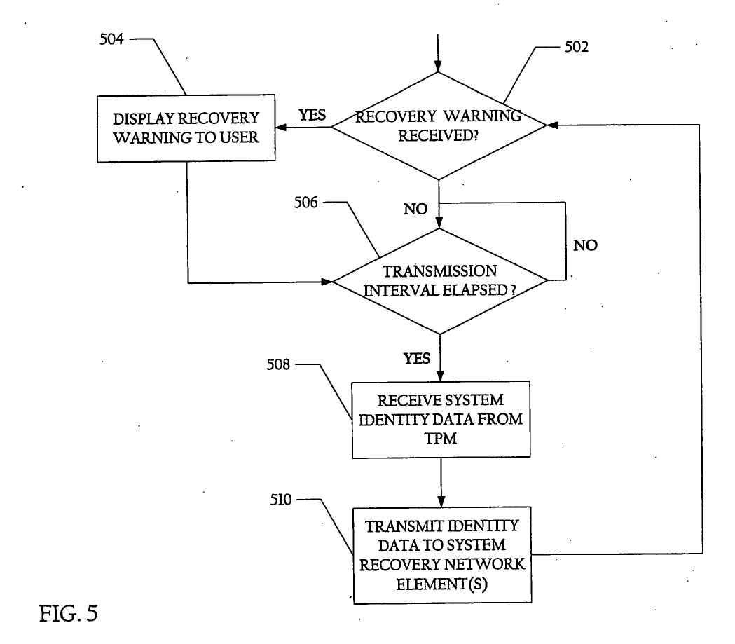

FIG. 5 illustrates a high-level flow diagram of a data processing system (e.g., application-level recovery program) operational process according to a second embodiment of the present invention. Such an embodiment may be utilized in addition to or in place of other embodiments such as those depicted in FIG. 4. In the illustrated process embodiment, an initial determination is made whether or not a recovery warning has been received (process block 502). Such a recovery warning may originate with a data processing system recovery network element or other element or entity within an associated network or may be generated internally to a data processing system in which the illustrated process is performed. If a determination is made that the receipt of such a recovery warning has occurred, a recovery warning (e.g., an audible or visual warning message or signal) is displayed or otherwise provide to a user of a data processing system in which the illustrated process is being performed (process block 504).

In various embodiments of the present invention such a recovery warning may take a variety of forms. For example, a user may be prompted for a password or other identifying data to discontinue a data processing system recovery process (e.g., further tracking of the data processing system, notification of authorities, or the like). Similarly, a user may simply be provided with a warning or notice indicating that the data processing system is lost or stolen and is currently being tracked in an attempt, for example, to cause thieves to abandon (or unknowing purchasers to report and/or return) a stolen system or device. In other embodiments of the present invention, such a recovery warning may be eliminated altogether, enabling a data processing system to be surreptitiously tracked (e.g., to apprehend a thief with the stolen system in hand).

If a determination is made that no recovery warning has been received or alternatively following the display or provision of such a recovery warning to a user, a subsequent determination is made whether a statically or dynamically generated or determined identity data transmission interval has elapsed (process block 506). Once a determination is made that the requisite time interval has elapsed, data processing system identity data is obtained from an associated TPM or other security processing element (process block 508) as shown. The collection of such identity data may be initiated and/or controlled by the illustrated process (e.g., application-level recovery program) itself, by the described TPM, or by another entity associated with a data processing system implementing the illustrated process embodiment. Thereafter, the obtained data processing system identity data is transmitted to one or more data processing system recovery network elements (process block 510), for example, a part of a identity data heartbeat signal, for use in tracking the physical location of the data processing system implementing the depicted method.

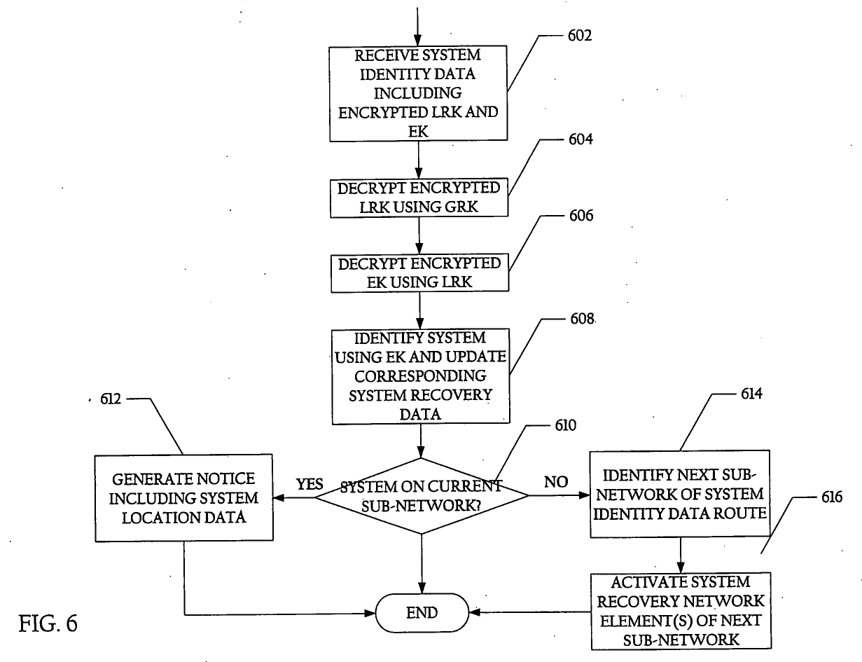

FIG. 6 illustrates a high-level flow diagram of a system recovery communications network element operational process according to an embodiment of the present invention. In the illustrated process embodiment, data processing system identity data such as that previously described is initially received which includes data specifying an encrypted form or version of at least a portion of each of a local recover key and a security processing element (e.g., TPM) endorsement key (process block 602). Following the receipt of the described identity data, its constituent local recovery key is decrypted using at least a portion of a corresponding global recovery key (processing block 604). The decrypted local recover key is then in turn used to decrypt the security processing element endorsement key (process block 606) such that data specifying the decrypted endorsement key may be utilized to identify an associated data processing system and to update corresponding locally stored data processing system recovery data (e.g., an associated network connection address) (process block 608).

Once such identifying and recovery data has been ascertained, a determination may then be made whether or not an identified data processing system is currently communicatively coupled to a current sub-network (e.g., a network segment to which a system recovery communications network element implementing the illustrated process embodiment is physically connected) (process block 610). If a determination may be made that the data processing system to be tracked is on the current sub-network a notice is generated including data specifying the data processing system's physical location (process block 612). Such a notice may be communicated to a user (e.g., owner) of the system in questions, to the authorities, or the like, or a combination thereof. In response to a determination that the data processing system to be tracked or “recovered” is not connected to the current sub-network, a “next” (e.g., hierarchically lower level) sub-network traversed by the received data processing system identity data is identified (process block 614) and a system recovery communications network element within the identified next sub-network is activated to perform the depicted process (process block 616) (e.g., via transmission of a loss notification as described herein).

Although the flow diagrams depicted in FIGS. 4-6 indicate a particular order of operation and a specific granularity of process operations, in alternative embodiments the illustrated orders may be varied (e.g., process operations may be performed in another order or performed substantially in parallel) and one or more of the process operations may be coalesced or fragmented. Similarly, addition process operations may be added where necessary in alternative embodiments of the present invention.

The present invention has been described in the context of fully functional data processing system; however, those skilled in the art will appreciate that the present invention is capable of being distributed as a program product in a variety of forms and applies equally regardless of the particular type of signal bearing media used to carry out the distribution. Examples of such signal bearing media include recordable media such as floppy disks and CD-ROM, transmission type media such as digital and analog communications links, as well as media storage and distribution systems developed in the future. Embodiments of the present invention may similarly be implemented utilizing software modules used to perform certain operations or tasks. The described software modules may include script, batch, or other executable files and may be stored on a machine-readable or computer-readable medium. Thus, the modules may be stored within a computer system memory to configure a data processing or computer system to perform one or more functions of a software module. Other new and various types of machine or computer-readable storage media may be used to store the modules discussed herein.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

Consequently, the invention is intended to be limited only by the scope of the appended claims, giving full cognizance to equivalents in all respects.

What is claimed is:

1. A method comprising:
receiving identity data from a data processing system via a communications network, wherein
said data processing system comprises a security processing element, and
said identity data comprises data which specifies a portion of a security processing element endorsement key stored within secure storage associated with said security processing element;
identifying said data processing system utilizing said data which specifies said portion of said security processing element endorsement key; and
causing recovery data corresponding to said data processing system to be stored in response to an identification of said data processing system, wherein
said recovery data comprises a network connection address associated with said data processing system.

2. The method of claim 1, wherein
said method is performed utilizing a first system recovery communications network element,
said first system recovery communications network element is associated with a public key infrastructure key pair comprising a public global recovery key and a private global recovery key,
said security processing element comprises a trusted platform module,
said security processing element endorsement key comprises a public key infrastructure key pair comprising a public trusted platform module endorsement key and a private trusted platform module endorsement key,
said identity data comprises data which specifies said public trusted platform module endorsement key and is encrypted utilizing said public global recovery key, and
identifying said data processing system comprises decrypting said identity data utilizing said private global recovery key.

3. The method of claim 2, wherein said identity data comprises an identity data record further comprising
first data which specifies a local recovery key and is encrypted utilizing said public global recovery key, and
second data which specifies said public trusted platform module endorsement key and is encrypted utilizing said local recovery key.

4. The method of claim 2, wherein
said recovery data comprises an Internet Protocol address associated with said data processing system, and
said method further comprises determining a physical location of said data processing system within said communications network utilizing said Internet Protocol address.

5. The method of claim 4, wherein
said method further comprises receiving a loss notification indicating said data processing system has been separated from an associated user, and
determining said physical location of said data processing system is performed in response to a receipt of said loss notification.

6. The method of claim 4, wherein determining said physical location of said data processing system comprises
identifying a sub-network of said communications network including said data processing system utilizing said Internet Protocol address,
activating a second system recovery communications network element within said sub-network, and
processing communications network traffic received at said second system recovery communications network element utilizing said identity data in response to an activation of said second system recovery communications network element.

7. The method of claim 2, wherein
receiving identity data comprises receiving a plurality of identity data messages on a periodic basis,
said method further comprises
detecting a cessation of transmission of said plurality of identity data messages, and
causing a warning message to be issued to a user in response a detection of said cessation.

8. A system comprising:
means for receiving identity data from a data processing system via a communications network, wherein
said data processing system comprises a security processing element, and
said identity data comprises data which specifies a portion of a security processing element endorsement key stored within secure storage associated with said security processing element;
means for identifying said data processing system utilizing said data which specifies said portion of said security processing element endorsement key; and
means for causing recovery data corresponding to said data processing system to be stored in response to an identification of said data processing system, wherein
said recovery data comprises a network connection address associated with said data processing system.

9. The system of claim 8, wherein
said system comprises a first system recovery communications network element,
said first system recovery communications network element is associated with a public key infrastructure key pair comprising a public global recovery key and a private global recovery key,
said security processing element comprises a trusted platform module,
said security processing element endorsement key comprises a public key infrastructure key pair comprising a public trusted platform module endorsement key and a private trusted platform module endorsement key,
said identity data comprises data which specifies said public trusted platform module endorsement key and is encrypted utilizing said public global recovery key, and
said means for identifying said data processing system comprises means for decrypting said identity data utilizing said private global recovery key.

10. The system of claim 9, wherein said identity data comprises an identity data record further comprising
first data which specifies a local recovery key and is encrypted utilizing said public global recovery key, and
second data which specifies said public trusted platform module endorsement key and is encrypted utilizing said local recovery key.

11. The system of claim 9, wherein
said recovery data comprises an Internet Protocol address associated with said data processing system, and
said system further comprises means for determining a physical location of said data processing system within said communications network utilizing said Internet Protocol address.

12. The data processing system of claim 11, wherein
said data processing system further comprises means for receiving a loss notification indicating said data processing system has been separated from an associated user, and
said means for determining comprises means for determining said physical location of said data processing system in response to a receipt of said loss notification.

13. The data processing system of claim 12, wherein said means for determining further comprises
means for identifying a sub-network of said communications network including said data processing system utilizing said Internet Protocol address,
means for activating a second system recovery communications network element within said sub-network, and
means for processing communications network traffic received at said second system recovery communications network element utilizing said identity data in response to an activation of said second system recovery communications network element.

14. The data processing system of claim 8, wherein
said means for receiving comprises means for receiving a plurality of identity data messages on a periodic basis,
said data processing system further comprises
means for detecting a cessation of transmission of said plurality of identity data messages, and
means for causing a warning message to be issued to a user in response a detection of said cessation.

15. A machine-readable medium having a plurality of instructions executable by a machine embodied therein, wherein said plurality of instructions when executed cause said machine to perform a method comprising:
receiving identity data from a data processing system via a communications network, wherein
said data processing system comprises a security processing element, and
said identity data comprises data which specifies a portion of a security processing element endorsement key stored within secure storage associated with said security processing element;
identifying said data processing system utilizing said data which specifies said portion of said security processing element endorsement key; and
causing recovery data corresponding to said data processing system to be stored in response to an identification of said data processing system, wherein
said recovery data comprises a network connection address associated with said data processing system.

16. The machine-readable medium of claim 15, wherein
said machine comprises a first system recovery communications network element,
said first system recovery communications network element is associated with a public key infrastructure key pair comprising a public global recovery key and a private global recovery key,
said security processing element comprises a trusted platform module,
said security processing element endorsement key comprises a public key infrastructure key pair comprising a public trusted platform module endorsement key and a private trusted platform module endorsement key,
said identity data comprises data which specifies said public trusted platform module endorsement key and is encrypted utilizing said public global recovery key, and
identifying said data processing system comprises decrypting said identity data utilizing said private global recovery key.

17. The machine-readable medium of claim 16, wherein said identity data comprises an identity data record further comprising
first data which specifies a local recovery key and is encrypted utilizing said public global recovery key, and
second data which specifies said public trusted platform module endorsement key and is encrypted utilizing said local recovery key.

18. The machine-readable medium of claim 16, wherein
said recovery data comprises an Internet Protocol address associated with said data processing system, and
said method further comprises determining a physical location of said data processing system within said communications network utilizing said Internet Protocol address.

19. The machine-readable medium of claim 18, wherein
said method further comprises receiving a loss notification indicating said data processing system has been separated from an associated user, and
determining said physical location of said data processing system is performed in response to a receipt of said loss notification.

20. The machine-readable medium of claim 18, wherein determining said physical location of said data processing system comprises
identifying a sub-network of said communications network including said data processing system utilizing said Internet Protocol address,
activating a second system recovery communications network element within said sub-network, and
processing communications network traffic received at said second system recovery communications network element utilizing said identity data in response to an activation of said second system recovery communications network element.
